(19) United States
(12) Patent Application Publication
(10) Pub. No.: US 2021/0398052 A1
(43) Pub. Date: Dec. 23, 2021

(54) WORK OPERATION ASSURANCE SYSTEM

(71) Applicant: SUBARU CORPORATION, Tokyo (JP)

(72) Inventors: Masazumi MIYAGO, Tokyo (JP); Takemi OGURI, Tokyo (JP); Hiroshi ASAKA, Tokyo (JP)

(21) Appl. No.: 17/321,806

(22) Filed: May 17, 2021

(30) Foreign Application Priority Data
Jun. 19, 2020 (JP) 2020-105842

(51) Int. Cl. G06Q 10/06; G06N 20/00; G06T 7/00; G06F 3/14; H04N 9/31

(52) U.S. Cl. CPC G06Q 10/06316; G06Q 10/06398; G06N 20/00; G06Q 10/087; G06F 3/14; H04N 9/31; G06T 7/0004

(57) ABSTRACT

A work operation assurance system includes an information projector, an imaging unit, and a processor. The information projector projects work information on a work object. The imaging unit obtains image data on an operator performing a work operation on the work object. The processor includes an artificial intelligence component that determines whether the work operation performed by the operator is appropriate based on the image data obtained by the imaging unit and work operation information preliminarily learned by the artificial intelligence component. In a case where the artificial intelligence component determines that the work operation performed by the operator is inappropriate, the processor causes the information projector to project a notification indicating that the work operation performed by the operator is inappropriate.

### CROSS-REFERENCE TO RELATED APPLICATIONS

The present application claims priority from Japanese Patent Application No. 2020-105842 filed on Jun. 19, 2020, the entire contents of which are hereby incorporated by reference.

### BACKGROUND

The technology relates to a work operation assurance system. For example, the technology relates to a work operation assurance system that makes it possible to cause an information projector to project work information on a work object.

A technique to assist work in a product manufacturing line has been known. According to the technique, images of tools to be used in the work and a procedure of the work may be displayed on a display located on the worksite. This assists an operator in assembling components into a product. Further, a sensor and a camera are provided to acquire information on operations performed by the operator. The operation information is analyzed by a computer to confirm if the work has been performed appropriately. That is, work operation assurance control is performed.

For example, Japanese Unexamined Patent Application Publication (JP-A) No. 2013-174980 discloses a work operation assurance system that includes an operation sensor and a controller. The operation sensor detects operations performed by an operator. The processor analyzes the data acquired by the operation sensor. The controller includes an initial registration unit and a determination unit. Proper operators operations on simple tasks are preliminarily registered in the initial registration unit. The determination unit determines if the operator's operations detected by the movement sensor match with the proper operations registered in the initial registration unit. If the determination unit does not determine that the operator's operations match with the proper operations registered in the initial registration unit, a warning appears on the display.

Such a combination of work assistance in human work processes and work operation assurance control enhances work efficiency and helps prevent an error in the work.

Further, another work assistance technique has been developed that causes a projector to project work information directly on a work object rather than a display.

For example, JP-A No. 2019-101603 discloses a work assistance system that includes a projector, an imaging unit, and a controller. The projector projects an image on a work object. The imaging unit captures an image of the work object. The controller switches an image projected by the projector on the basis of the image data acquired by the imaging unit. The projector projects work information about a predetermined work process on the work object. The controller determines if the predetermined work process has been completed on the basis of the image data acquired by the imaging unit. If it is determined that the predetermined work process has been completed, the controller causes the projector to project work information about the next work process.

According to the work assistance system, the work information is projected directly on the work object by the projector. This helps assist the operator in working on the work object by eliminating the necessity for the operator to move his/her eyes from the work object. This also helps prevent an experienced operator from automatically performing the work without following the work information and making mistakes based on an erroneous assumption or guess, for example.

### SUMMARY

An aspect of the technology provides a work operation assurance system including an information projector, an imaging unit, and a processor. The information projector is configured to project work information on a work object. The imaging unit is configured to obtain image data on an operator performing a work operation on the work object. The processor includes an artificial intelligence component configured to determine whether the work operation performed by the operator is appropriate on the basis of the image data obtained by the imaging unit and work operation information preliminarily learned by the artificial intelligence component. In a case where the artificial intelligence component determines that the work operation performed by the operator is inappropriate, the processor is configured to cause the information projector to project a notification on the work object. The notification indicates that the work operation performed by the operator is inappropriate.

An aspect of the technology provides a work operation assurance system including an information projector, an imaging unit, and circuitry. The information projector is configured to project work information on a work object. The imaging unit is configured to obtain image data on an operator performing a work operation on the work object. The circuitry includes an artificial intelligence component configured to determine whether the work operation performed by the operator is appropriate on the basis of the image data obtained by the imaging unit and work operation information preliminarily learned by the artificial intelligence component. In a case where the artificial intelligence component determines that the work operation performed by the operator is inappropriate, the circuitry is configured to cause the information projector to project a notification on the work object. The notification indicates that the work operation performed by the operator is inappropriate.

### BRIEF DESCRIPTION OF THE DRAWINGS

The accompanying drawings are included to provide a further understanding of the technology and are incorporated in and constitute a part of this specification. The drawings illustrate example embodiments and, together with the specification, serve to explain the principles of the technology.

FIG. 1 is a schematic view of a work operation assurance system according to one example embodiment of the technology.

FIG. 2 is a block diagram illustrating an exemplary configuration of the work operation assurance system according to one example embodiment of the technology.

FIG. 3 is a flowchart illustrating a process performed by a processor to control an information projector.

### DETAILED DESCRIPTION

While work information is projected directly on a work object, an operator working on the work object focuses his/her eyes and attention on the work object. The operator in such a state tends to keep working on the work object without recognizing a warning about an inappropriate work operation appearing on a display.

If the operator recognizes that the work operation has been performed inappropriately after completing the work, the operator can find it difficult to identify which operation has been performed inappropriately.

It is desirable to provide a work operation assurance system that projects work information on an work object to assist an operator in performing a work operation on the work object and that makes the operator certainly recognize that the work operation has been performed inappropriately.

Some example embodiments of the technology will now be described in detail with reference to the accompanying drawings. Note that the following description is directed to illustrative examples of the technology and not to be construed as limiting to the technology. Factors including, without limitation, numerical values, shapes, materials, components, positions of the components, and how the components are coupled to each other are illustrative only and not to be construed as limiting to the technology. Further, elements in the following example embodiments that are not recited in a most-generic independent claim of the technology are optional and may be provided on an as-needed basis. The drawings are schematic and are not intended to be drawn to scale. Throughout the present specification and the drawings, elements having substantially the same function and configuration are denoted with the same numerals to avoid any redundant description.

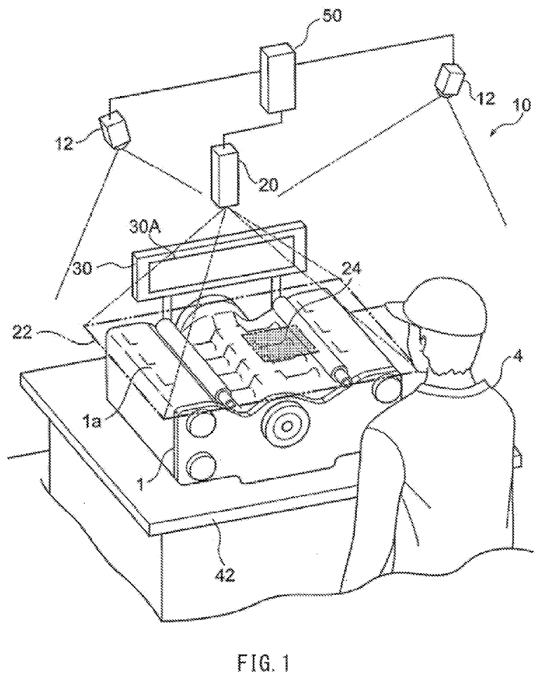

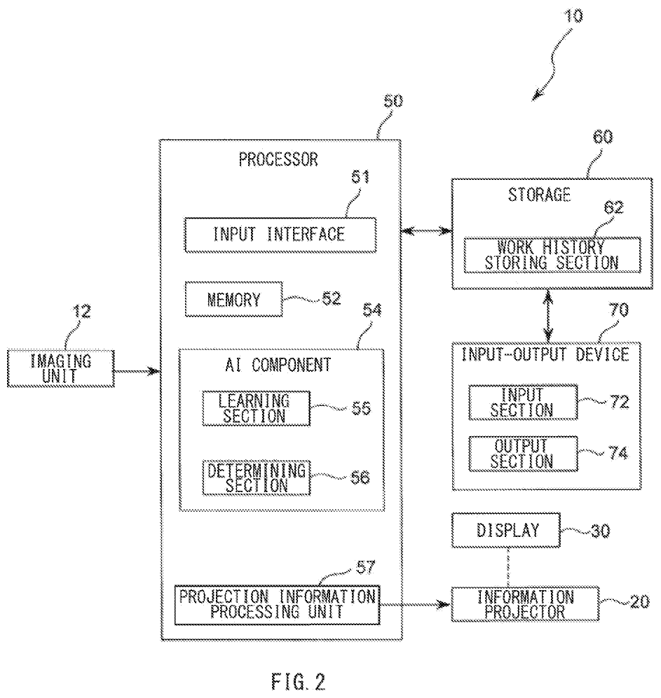

FIG. 1 is a schematic view of a work operation assurance system 10 according to an example embodiment of the technology. FIG. 2 is a block diagram illustrating an exemplary configuration of the work operation assurance system 10. The work operation assurance system 10 may perform work operation assurance to confirm if a work operation performed by the operator on the work object is appropriate. In the example illustrated in FIG. 1, the work object may be an engine structure 1 to be mounted on a vehicle.

The work operation assurance system 10 according to the present example embodiment includes an information projector 20, a display 30, an imaging unit 12, and a processor 50. The information projector 20 projects work information on the engine structure 1. The display 30 may display the work information projected by the information projector 20 on the engine structure 1. The imaging unit 12 may obtain image data on an operator 4 performing a work operation on the engine structure 1. The processor 50 controls the information projector 20 on the basis of the image data acquired from the imaging unit 12. The work operation assurance system 10 may further include a storage 60 and an input-output device 70. The storage 60 may store a work history received from the processor 50. The input-output device 70 may communicate with the storage 60. Note that the illustrations of the storage 60 and the input-output device 70 are omitted in FIG. 1.

The information projector 20 may project electronic information, such as text data or image data, received from the processor 50 in the form of an image on the target object. The information projector 20 may be, for example, a digital light processing (DLP) projector or a liquid crystal projector. The work operation assurance system 10 may employ a so-called projection mapping technology that makes it possible to project an image not only on a flat screen but also on a curved surface of a three-dimensional object using the information projector 20 and the processor 50. For example, the work operation assurance system 10 may project the work information about tools to be used to assemble the engine and an assembling procedure on a surface 1a of the engine structure 1 having a three-dimensional body.

In the example illustrated in FIG. 1, the information projector 20 may be a single projector. However, two information projectors may be provided in another example embodiment. In FIG. 1, an information projection region 22 of the information projector 20 is indicated by dashed-two dotted lines. The information projector 20 may project an image on a part of the information projection region 22 in a dotted region 24 illustrated in FIG. 1, for example. Projecting the information on the dotted region 24, which is a part of the information projection region 22, makes it possible to clearly indicate a portion to be processed by the operator 4.

The display 30 may display the work information projected by the information projector 20 on the engine structure 1. For example, the display 30 may be a white board or a screen. In FIG. 1, the information projector 20 may project information 30A on the display 30. The display 30 may be disposed near the engine structure 1 so that the information 30A appearing on the display 30 is recognizable by the operator 4 working on the engine structure 1. In the present example embodiment, the display 30 may be disposed near a workbench 42 on which the engine structure 1 is placed.

The imaging unit 12 may capture an image. For example, the imaging unit 12 may include a camera that captures a moving image. In the present example embodiment, the imaging unit 12 may include a stereo camera that captures images of a target area from two different directions at the same time and measures the distance to a target object in the target area. The imaging unit 12 may be disposed so as to capture an image of the operator 4 working on the engine structure 1 on the worksite. The imaging unit 12 may capture an image of skeletal movements or line-of-sight movements of the operator 4, for example. In the present example embodiment, the imaging unit 12 may be disposed so as to capture an image of the operator 4 and an image of the engine structure 1.

The processor 50 may be a calculator including a microcomputer. The processor 50 may include an information processing unit, such as a central processing unit (CPU) or an application specific integrated circuit (ASIC), and a memory, such as RAM or ROM, for example. For example, the processor 50 may read and execute programs stored in the memory using the CPU to achieve various functions, such as serving as a control unit, a calculation unit, and a processing unit.

As illustrated in FIG. 2, the processor 50 may include an input interface 51, a memory 52, an artificial intelligence (AI) component 54 that includes a learning section 55 and a determining section 56, and a projection information processing unit 57 that controls information to be projected by the information projector 20.

The input interface 51 of the processor 50 may be used to input information to the processor 50. The input interface 51 may be a keyboard, a mouse, or a touch screen, for example. The information inputted using the input interface 51 may be stored in the memory 52.

The memory 52 of the processor 50 may store programs for various processing and data on work information to be projected by the information projector 20. In the present example embodiment, the data on work information may include, for example, data on multiple work steps for assembling an engine, parts and tools used in each work step, and the procedure of the work.

The memory 52 may further include information on work operations to be performed by the operator 4 on the engine structure 1 (hereinafter also referred to as work operation information. The work operation information may include information on appropriate work operations on the engine structure 1 and inappropriate work operations on the engine structure 1.

The learning section 55 in the AI component 54 learns the appropriate work operations and the inappropriate work operations on the basis of the work operation information stored in the memory 52. The determining section 56 in the AI component 54 determines whether a work operation performed by the operator 4 is appropriate on the basis of the image data acquired by the imaging unit 12 and the work operation information preliminarily learned by the learning section 55.

For example, for a work step in which the operator 4 should remove oil on the surface 1a of the engine structure 1, the learning section 55 may learn that repeating an operation of removing oil from one portion of the engine structure 1 three times is an appropriate work operation, and that repeating the operation of removing the oil from the one portion of the engine structure 1 twice is an inappropriate work operation.

The determining section 56 may determine whether the work operation performed by the operator 4 is appropriate on the basis of the information learned by the learning section 55 and operation information included in the image data acquired by the imaging unit 12 and indicating the operation of the operator 4. For example, in a case where the image data includes operation information indicating that the operator 4 has repeated the operation of removing oil from one portion of the engine structure 1 four times, the determining section 56 may determine that the operation performed by the operator 4 is appropriate because the operation performed by the operator 4 belongs to an appropriate work operation range. In contrast, in a case where the image data includes operation information indicating that the operator 4 has performed the operation of removing oil from one portion of the engine structure 1 only once, the determining section 56 may determine that the operation performed by the operator 4 is inappropriate because the operation performed by the operator 4 belongs to an inappropriate work operation range. In another case where the image data includes information on coughing or sneezing behaviors of the operator 4, the determining section 56 may make no determination because these behaviors belong to neither the appropriate work operation range nor the inappropriate work operation range.

The projection information processing unit 57 in the processor 50 causes the information projector 20 to project the work information on the basis of the data stored in the memory 52 in accordance with the program registered in the processor 50. Further, in a case where the determining section 56 determines that the work operation performed by the operator 4 is inappropriate while the information projector 20 is projecting the work information, the projection information processing unit 57 may cause the information projector 20 to project an inappropriate work operation notification indicating that the work operation performed by the operator on the engine structure 1 is inappropriate.

In the present example embodiment, the inappropriate work operation notification projected by the projection information processing unit 57 may be a first inappropriate work operation notification. The first inappropriate work operation notification may be the work information projected by the information projector 20 on the engine structure 1 while the work operation was being performed inappropriately. Alternatively, the inappropriate work operation notification may be a second inappropriate work operation notification the operation. The second inappropriate work operation notification may be information included in the image data and indicating the work operation of the operator 4 determined as being inappropriate. Still alternatively, the inappropriate work operation notification may be a third inappropriate work operation notification. The third inappropriate work operation notification may be text information or image information preliminarily stored in the memory 52 and indicating that the work operation performed by the operator 4 is inappropriate.

Further, in a case where the determining section 56 determines that the work operation performed by the operator 4 is inappropriate, the projection information processing unit 57 may cause the information projector 20 to project the inappropriate work operation notification on the display 30. The inappropriate work operation notification projected on the display 30 may be the information projected by the information projector 20 on the engine structure 1 while the work operation was being performed inappropriately (i.e., the first inappropriate work operation notification), the information included in the image data acquired by the imaging unit 12 and indicating the work operation of the operator 4 determined as being inappropriate (i.e., the second inappropriate work operation notification), or the text information or the image information preliminarily stored in the memory 52 and indicating that the work operation performed by the operator 4 is inappropriate (i.e., the third inappropriate work operation notification).

The projection information processing unit 57 may project the same inappropriate work operation notification on the engine structure 1 and the display 30 or different inappropriate work operation notifications respectively on the engine structure 1 and the display 30. For example, the projection information processing unit 57 may project one of the first inappropriate work operation notification and the second inappropriate work operation notification on the engine structure 1, and project the other of the first inappropriate work operation notification and the second inappropriate work operation notification on the display 30.

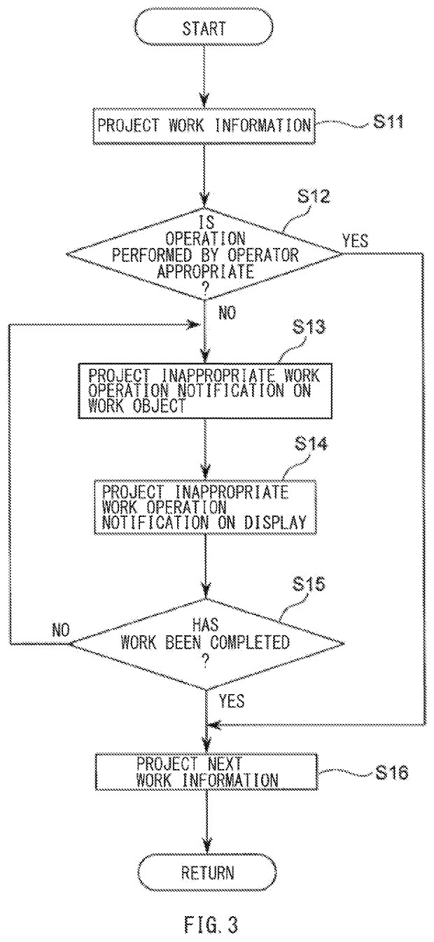

Next, the process performed by the processor 50 in the work operation assurance system 10 to control the information projector 20 is described with reference to FIG. 3.

When the work operation assurance system 10 is activated, the AI component 54 in the processor 50 may recognize the engine structure 1 placed on the workbench 42 on the basis of the image data acquired by the imaging unit 12. Based on the result of recognition by the AI component 54, the projection information processing unit 57 may start controlling the information projector 20. Upon the start of the control, the projection information processing unit 57 may retrieve the work information relevant to the operation to be performed on the engine structure 1 from the memory 52, and cause the information projector 20 to project the work information on the engine structure 1 (Step S11).

After the work information is projected on the engine structure 1, the AI component 54 may determine whether a work operation performed by the operator 4 is appropriate on the basis of the image data acquired by the imaging unit 12 and the work operation information preliminarily learned by the learning section 55 (Step S12). If the AI component 54 determines that the work operation performed by the operator 4 is appropriate (Step S12: YES), the projection information processing unit 57 may project next work information following the current work information on the engine structure 1 in accordance with the program registered in the processor 50 (Step S16), and cause the procedure to return.

If the AI component 54 determines that the work operation performed by the operator 4 is inappropriate in Step S12 (Step S12: NO), the projection information processing unit 57 may cause the information projector 20 to project the inappropriate work operation notification on the work object, namely, the engine structure 1 (Step S13), and on the display 30 (Step S14).

After the inappropriate work operation notification is projected, the AI component 54 may determine whether the work operation determined as being inappropriate has now been performed appropriately on the basis of the image data acquired by the imaging unit 12. That is, the AI component 54 may determine whether the work has been completed appropriately (Step S15).

Like the determination in Step S12, the determination in Step S15 may be performed by the AI component 54 that determines whether the work operation has been performed appropriately. Alternatively, when the operator 4 performs a predetermined operation indicating completion of the work, the AI component 54 may determine that the work has been completed appropriately on the basis of the image data of the operation indicating the completion of the work. For example, the information projector 20 may project an image of a work completion button as well as the inappropriate work operation notification on the engine structure 1. The AI component 54 may determine that the work has been completed appropriately when the operator 4 puts the hand above the image of the work completion button. Even if AI component 54 wrongly determines that the work operation performed by the operator 4 is inappropriate in Step S12, the operator 4 may promptly move on to the next work by performing the predetermined operation indicating the completion of the work. Additionally, such information acquired from the image data may be learned by the learning section 55 in the AI component 54. This improves the determination accuracy of the determining section 56.

If it is determined that the work has been completed (Step S15: YES), the projection information processing unit 57 may project the work information on the next work to be performed on the engine structure 1 (Step S16), and cause the procedure to return. The inappropriate work operation notification may be projected until it is determined that the work has been completed (Step S15: NO).

The work operation assurance system 10 according to the example embodiment described above causes the information projector 20 to project the work information on the engine structure 1 to assist the work. The AI component 54 determines whether the work operation performed by the operator 4 is appropriate on the basis of the image data on the work operation performed by the operator 4 acquired by the imaging unit 12 and the work operation information preliminarily learned by the AI component 54. If the AI component 54 determines that the work operation performed by the operator 4 is inappropriate, the information projector 20 may project the inappropriate work operation notification on the engine structure 1 placed in front of the operator 4. Accordingly, it is possible to make the operator 4 certainly recognize that the working operation has been performed inappropriately.

Further, the work information on the next work may not be projected while the inappropriate work operation notification is being projected on the engine structure 1. This encourages the operator 4 to certainly perform the current work operation appropriately before moving on to the next work.

Further, the first inappropriate work operation notification, i.e., the work information projected by the information projector 20 while the inappropriately work operation was being performed on the engine structure 1, may be projected as the inappropriate work operation notification on the engine structure 1. This allows the operator 4 to perform the work operation appropriately in accordance with the work information projected again.

Further, the second inappropriate work operation notification, i.e., the information included in the image data and indicating the work operation of the operator 4 determined as being inappropriate, is projected as the inappropriate work operation notification on the engine structure 1. This allows the operator 4 to recognize which operation has been performed inappropriately.

Further, the dedicated display 30 may be provided separately from the engine structure 1, and the inappropriate work operation notification may be projected on the display 30. This allows the operator 4 to more easily recognize the information projected by the information projector 20. Alternatively, the first inappropriate work operation notification and the second inappropriate work operation notification may be projected respectively on the engine structure 1 and the display 30. This achieves more efficient work assistance to the work determined as being inappropriate.

Further, the work operation assurance system 10 determines whether the work operation performed by the operator is appropriate using the AI component 54 having the learning function. This eliminates the need to register a large amount of reference data for the determination in the processor 50 at initial setting. For example, a process of assembling the engine structure 1 is complicated and involves a large number of work steps. However, using the AI component 54 reduces the amount of data to be initially registered.

The storage 60 and the input-output device 70 in the work operation assurance system 10 will now be described.

The storage 60 may store various pieces of information and may be communicable with the processor 50 and the input-output device 70, for example. The storage 60 may be incorporated in the processor 50 in another example embodiment. The storage 60 may include a work history storing section 62 that stores the history of the work performed on the work object (hereinafter referred to as work history information). The work history information stored in the work history storing section 62 may include the product serial number of the work object and the information on the work operation performed by the operator 4 on the work object. The product serial number of the work object and the information on the work operation performed on the work object may be correlated with each other. These pieces of information may be transmitted to the storage 60 via the processor 50 or the input-output device 70.

In the present example embodiment, the work history storing section 62 may store the work history information that includes the product serial number of the engine structure 1 and the work operation information used by the AI component 54 to determine whether the work operation performed on the engine structure 1 was appropriate. The product serial number and the work operation information may be correlated with each other. The work operation information may be information on the work performed on the engine structure 1 or image data acquired by the imaging unit 12 during the process of assembling the engine structure 1. Herein, the product serial number of the engine structure 1 may refer to a serial number assigned to an engine including the engine structure 1 or a serial number assigned to a vehicle including the engine.

The input-output device 70 may include an input section 72 that receive information, and an output section 74 that outputs information. For example, the input section 72 may be a key board or a touch screen, and the output section 74 may be a display. The input-output device 70 may be a personal computer or a tablet device, for example.

When receiving the product serial number of the engine structure 1 via the input section 72, the input-output device 70 may retrieve the work operation information correlated with the product serial number from the storage 60, and output the retrieved information to the output section 74.

The work operation assurance system 10 including the storage 60 and the input-output device 70 described above may enables the work information used in the process of assembling the engine structure 1 to be used in a subsequent process, such as an intermediate inspection process, a final inspection process, or a post-marketing process. For example, in a case where a malfunction is found in an engine in an inspection process, the product serial number of the engine may be inputted to the input-output device 70 placed on an inspection site to cause the output section 74 of the input-output device 70 to display the work operation correlated with the product serial number. This makes it possible to confirm the work operation performed in the process of assembling the engine, and helps identify the cause of the malfunction on the basis of the work history information.

Although some example embodiments of the technology have been described in the foregoing by way of example with reference to the accompanying drawings, the technology is by no means limited to the example embodiments described above. It should be appreciated that modifications and alterations may be made by persons skilled in the art without departing from the scope as defined by the appended claims. The technology is intended to include such modifications and alterations in so far as they fall within the scope of the appended claims or the equivalents thereof.

For example, the work operation assurance system 10 may have a configuration not including the display 30, the storage 60, and the input-output device 70.

According to the example embodiments of the technology described above, when the work assistance is performed that causes the information projector to project the work information on the work object, the AI unit determines whether the work operation performed by the operator is appropriate on the basis of the image data of the work operation of the operator captured by the imaging unit and and the work operation information preliminarily learned by the AI unit. If the AI unit determines that the work operation performed by the operator is inappropriate, the inappropriate work operation notification is projected on the work object placed in front of the operator by the information projector. Accordingly, it is possible to make the operator certainly recognize that the work operation has been performed inappropriately. Further, the determination as to whether the work operation performed by the operator is appropriate is performed by the AI unit having the learning function. This eliminates the need to register a large amount of reference data for the determination in the processor at initial setting.

If the AI unit determines that the work operation performed by the operator is inappropriate, the first inappropriate work operation notification, i.e., the work information projected by the information projector while the work operation was being performed inappropriately, or the second inappropriate work operation notification, i.e., the information included in the image data and indicating the work operation of the operator determined as being inappropriate, may be projected, whereas the work information on the next work step may not be projected on the work object. Accordingly, it is possible to make the operator certainly recognize that the work operation has been performed inappropriately.

If the AI unit determines that the work operation performed by the operator is inappropriate, the first inappropriate work operation notification, i.e., the work information projected by the information projector while the work operation was being performed inappropriately, or the second inappropriate work operation, i.e., the information included in the image data and indicating the work operation of the operator determined as being inappropriate, may be projected on the display disposed near the work object. Such information displayed on the dedicated display rather than the work object is more easily recognized by the operator. Accordingly, it is possible to make the operator certainly recognize that the work operation has been performed inappropriately.

Further, when the user inputs the product serial number of the work object to the input-output device, the input-output device may output the work operation information correlated with the product serial number. This allows the work history information to be used in a process after the work, for example. According to the foregoing example embodiments of the technology, it is possible to provide the work operation assurance system that projects work information on an work object to assist an operator in performing a work operation on the work object and that makes the operator certainly recognize that the work operation has been performed inappropriately.

The processor 50 in the work operation assurance system 10 illustrated in FIG. 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processor 50. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processor 50 in the work operation assurance system 10 illustrated in FIG. 2.

1. A work operation assurance system comprising:
an information projector configured to project work information on a work object;
an imaging unit configured to obtain image data on an operator performing a work operation on the work object; and
a processor including an artificial intelligence component configured to determine whether the work operation performed by the operator is appropriate on a basis of the image data obtained by the imaging unit and work operation information preliminarily learned by the artificial intelligence component, wherein
the processor is configured to cause the information projector to project a notification on the work object in a case where the artificial intelligence component determines that the work operation performed by the operator is inappropriate, the notification indicating that the work operation performed by the operator is inappropriate.

2. The work operation assurance system according to claim 1, wherein
the processor is configured to cause the information projector to project a first notification or a second notification on the work object in a case where the artificial intelligence component determines that the work operation performed by the operator is inappropriate, the first notification corresponding to the work information projected by the information projector while the work operation was being performed inappropriately, the second notification corresponding to information included in the image data and indicating the work operation of the operator determined as being inappropriate.

3. The work operation assurance system according to claim 1, further comprising
a display disposed near the work object in a work region and configured to display information projected by the information projector, wherein,
the processor is configured to cause the information projector to project a first notification or a second notification on the display in a case where the artificial intelligence component determines that the work operation performed by the operator is inappropriate, the first notification corresponding to the work information projected by the information projector while the work operation was being performed inappropriately, the second notification corresponding to information included in the image data and indicating the work operation of the operator determined as being inappropriate.

4. The work operation assurance system according to claim 2, further comprising
a display disposed near the work object in a work region and configured to display information projected by the information projector, wherein,
the processor is configured to cause the information projector to project the first notification or the second notification on the display in a case where the artificial intelligence component determines that the work operation performed by the operator is inappropriate, the first notification corresponding to the work information projected by the information projector while the work operation was being performed inappropriately, the second notification corresponding to the information included in the image data and indicating the work operation of the operator determined as being inappropriate.

5. The work operation assurance system according to claim 1, further comprising:
a storage configured to store work history information including a product serial number of the work object and the work operation information used by the artificial intelligence component to determine whether the work operation performed on the work object was appropriate, the product serial number and the work operation information being correlated with each other; and
an input-output device configured to receive and output information, and retrieve, when receiving the product serial number, the work operation information correlated with the product serial number from the storage and output the retrieved work operation information.

6. The work operation assurance system according to claim 2, further comprising:
a storage configured to store work history information including a product serial number of the work object and the work operation information used by the artificial intelligence component to determine whether the work operation performed on the work object was appropriate, the product serial number and the work operation information being correlated with each other; and
an input-output device configured to receive and output information, and retrieve, when receiving the product serial number, the work operation information correlated with the product serial number from the storage and output the retrieved work operation information.

7. The work operation assurance system according to claim 3, further comprising:
a storage configured to store work history information including a product serial number of the work object and the work operation information used by the artificial intelligence component to determine whether the work operation performed on the work object was appropriate, the product serial number and the work operation information being correlated with each other; and
an input-output device configured to receive and output information, and retrieve, when receiving the product serial number, the work operation information correlated with the product serial number from the storage and output the retrieved work operation information.

8. The work operation assurance system according to claim 4, further comprising:
a storage configured to store work history information including a product serial number of the work object and the work operation information used by the artificial intelligence component to determine whether the work operation performed on the work object was appropriate, the product serial number and the work operation information being correlated with each other; and
an input-output device configured to receive and output information, and retrieve, when receiving the product serial number, the work operation information correlated with the product serial number from the storage and output the retrieved work operation information.

9. A work operation assurance system comprising:
an information projector configured to project work information on a work object;
a camera configured to obtain image data on an operator performing a work operation on the work object; and
circuitry including an artificial intelligence component configured to determine whether the work operation performed by the operator is appropriate on a basis of the image data obtained by the camera and work operation information preliminarily learned by the artificial intelligence component, wherein
the circuitry is configured to cause the information projector to project a notification on the work object in a case where the artificial intelligence component determines that the work operation performed by the operator is inappropriate, the notification indicating that the work operation performed by the operator is inappropriate.
